(19) United States
(12) Patent Application Publication
(10) Pub. No.: US 2016/0212945 A1
(43) Pub. Date: Jul. 28, 2016

(54) Fodder Growing System and Method

(71) Applicant: FOODER SOLUTIONS HOLDINGS PTY LTD, Top Camp (AU)

(72) Inventors: Terry Dean COLLESS, Toowoomba (AU); Flavio RACCANELLO, Toowoomba (AU)

(73) Assignee: Fodder Solutions Holdings Pty Ltd, Top Camp (AU)

(21) Appl. No.: 14/915,245

(22) PCT Filed: Aug. 29, 2013
(86) PCT No.: PCT/AU2013/000968

§ 371 Date: Feb. 28, 2016

(51) Int. Cl. A01G 9/14; A01G 9/24; A01G 9/20

(52) U.S. Cl. CPC A01G 9/14; A01G 9/20; A01G 9/245; A01G 9/247

(57) ABSTRACT

There is provided a fodder growing system (10) comprising a building slab 11 and insulated walls and roof panels 16 to form an insulated housing. A plurality of vertically-spaced, thermally massive MgO composite platforms (41) is supported at each end by uprights (34) and stringers (37, 40). The platform (41) is inclined 4° downward to a substantially unobstructed front edge. An irrigation system includes control means (51) for delivery of a selected, six-day irrigation program from a water supply (23, 26) to spray nozzles (45) supported over each of said platforms (41). An illumination system controlled by the control means (51) drives LED arrays (not shown) supported over each of said platforms (41). Temperature control means comprises a thermal collector (25) heating hot water supply (26) blended by a tempering valve with the cold water supply under the control of the control means (51) to control the temperature within the housing by controlling the temperature of the water supply.

### FIELD OF THE INVENTION

This invention relates to fodder growing, and more particularly to a system and method for growing fodder.

### DISCUSSION OF RELATED ART

The challenge of providing nutritious animal feed in times of seasonal shortage has been met throughout the history of animal husbandry by many processes. In highly seasonal regions, landscapes have been made over to meadowing for the purposes of seasonal hay production. Silage crops may be put in, harvested and appropriately stored. These historically European methods are not always available for use other environments lacking the land, climate or culture of husbandry to put in adequate feed stocks.

In many parts of the world, land may be plentiful but growing conditions are poor. Temperatures and/or rainfall may be too extreme to grow fodder dependably throughout the year. In such situations, pastoralists need to buy feed from outside sources, which is generally more expensive than growing the feed themselves. Therefore, there is a need for a growing system and methods that allows farmers to grow fodder for livestock in conditions where the general conditions are not favourable for growing fodder.

There have been many proposals for such a system. The applicant's own Australian Patent Application No. 2007201138 provided a transportable fodder production unit comprising an insulated container. The insulated container contained a racking system, an irrigation system, a lighting system and a thermal control system. The racking system had a plurality of shelves extending from the rear of the container to the front of the container, the shelves being of sufficient width to receive at least one fodder growing tray and of sufficient depth to receive a predetermined number of rows of trays to cycle through the container in a growing period. By this means, seeded trays can be loaded onto the rear of the shelves and trays with mats of grown fodder can be removed from the front of the shelves, said trays being urged forward by an operator as the fodder progresses through the growing period. The irrigation system comprised a plurality of spray heads positioned in the racking system for periodically spraying each tray with a predetermined volume of water. The lighting system was empirically operated fluorescent lighting to maintain a predetermined illumination. The thermal control unit comprised a reverse cycle AC unit to maintain the temperature within a predetermined temperature range.

This system and the method of its use had the advantage of portability, and were widely copied in Africa. However, the system has inherent capacity constraints imposed by the container size and “flow through” system of operation. In addition, portability and footprint constraints required significant energy inputs.

Later developments of the system evolved to fixed installations comprising a purpose-built building, preferably insulated and including a vertical array of slabs each having an top surface to support plants grown from seed on the slabs, spacing members arranged to vertically separate adjacent slabs, an irrigation system having outlets located to water the plants, and at heating pipes associated with each slab for circulating a fluid therethrough for maintaining the plants within a temperature range for enhanced growth. Specific embodiments included a method for growing plants including providing such a vertical array of slabs each including a heat exchange pipe, distributing plant seeds on top surfaces of the slabs, providing an automated irrigation system to irrigate the seeds based on an irrigation schedule, and applying light to the top surfaces of the slabs to encourage growth of the seeds. An additional step of forcing air over the top surfaces of the slabs to ventilate the plants provided multiple benefits.

The energy demands of the system were moderated by the heating of the thermally massive slabs via the heat exchange pipes. Circulating liquids in the heat exchange pipe system may be heated by solar thermal means. However, the slabs are inherently heavy and expensive to transport. In order that the slabs are able to be handled, they are inherently restricted in size. Circulated heat exchange piping represents an installation and operational complexity.

The present invention has an object of providing an alternative to the foregoing state of the art installations and having specific benefits there over.

### SUMMARY OF THE INVENTION

According to a first aspect of the present invention there is provided a fodder growing system including:
an insulated housing;
a plurality of vertically-spaced platforms supported in said housing, each platform being supported at each of spaced end portions, the end portions being interconnected by a rear edge and a substantially unobstructed front edge, said platform being inclined downward from said rear edge to said front edge;
an irrigation system including irrigation control means for delivery of a selected irrigation program from a water supply to spray nozzles supported over each of said platforms;
an illumination system including illumination control means controlling a lighting means supported over each of said platforms; and
temperature control means controlling the temperature within said housing by controlling the temperature of said water supply.

The housing may take the form of a slab-on-ground or suspended floor building. The building may be formed of metal-clad insulated panels, either as a stressed-skin structure or fully or partially framed. The housing is preferably provided with at least one opening in the form of a door; this may comprise one or more of a simple personal access door, and one or more doors admitting trolleys or carts for moving seed in and produce out.

The housing may comprise a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls. The opposed openings may define a passage through the building, and may be provided with on and/or off ramps as required. The passage may be defined within the housing by platforms on one or both sides of the passage. The housing may accommodate any selected number of platform assemblies in end to end relation, confined only by the dimensions of the housing. Having an opening door at either end of the passage enables cooling of enclosure in summer by way of ventilation of air mass in room.

Operational ventilation may be provided in order to control the O₂/CO₂ balance and condensing atmosphere in the housing. During a lighting cycle late in the growing phase, the fodder mat is both respiring (i.e. using O₂) and photosynthesizing (i.e. using CO₂ but generating O₂). However, all through the germination stage and until the biomass of cells including chloroplasts predominates, the plants are exclusively respiring, which can cause the O₂ level to drop significantly below the normal 159 mm Hg partial pressure. There may be provided a fan assembly operable as one or more of a blower, extractor or recirculator of the air inside the housing. The fan assembly is preferably located high in the housing to work in the “hot zone” and to avoid ground level dust and dirt being injected. The ventilation may be operable by control means to effect a fresh air change, which is needed to balance the air composition in the housing and to inhibit the growth of moulds. For example there may be provided a purge program for a fresh air change of about two housing volumes per day. The ventilation may include air conditioning means for use extreme external environmental conditions. The ventilation arrangement may include selective or incidental operation of the doors.

The platforms may each comprise a self-supporting sheet of material, or may comprise a rack assembly supporting a plurality of platform members. For example, the rack assembly may comprise a frame and/or stringer assembly with platform members each comprising a sheet of material supported by it. The material is preferably a chemically and biologically inert, waterproof and non-absorbent surface. Self-supporting platforms may comprise a composite panel such as carbon fibre/epoxy laminates. Composite panels may comprise a foam core and may include internal stringers. Composite panels may include filled abuse layers such as “artificial stone” surfaces produced by binding powdered rock with an epoxy binder. Such surface layers may also increase the thermal mass of the panel.

The platform may comprise an industrial material such as compressed fibre cement sheeting. In some embodiments of the invention the panel material is selected to have a high thermal mass such as from MgO derived hydraulic mineral panels, mineral-filled panels based on resin binders such as “artificial stone” composites, or the like, the material being selected for its relatively high specific heat. Panels of a material that is not inherently sealed may be sealed by a suitable sealer. For example panels may be sealed by a penetrating epoxy primer/sealer. The surface properties of the platform may be selected, of the platform coated, whereby the grown fodder mat (with its interwoven root structure) may be readily stripped by dragging the mat off the free lower edge of the platform. The mat is relatively heavy and may exceed a 20 kg OH&S limit. It may accordingly be permitted to drop onto a wheeled trolley or the like selected to operate in the passage through the housing.

The platforms may be substantially flat on their upper surface between boundary edges thereof. It is preferred that the flat platform upper surface extend to an uninterrupted sheer boundary at the front edge.

The platforms may be supported by a racking arrangement wherein uprights supporting or suspending the platforms are located at the spaced end portions. The spaced end portions may comprise respective end edges of the platform, meeting the front and rear edges at respective corners. An upright may support the platform and be located at a selected position adjacent an end edge between the respective corners.

The platforms may possess any selected vertical spacing dependent on the need for overhead clearance for growth, the need for irrigation and lighting to be above the maximum sprout height, and the desire for the most intensive agriculture per square meter of footprint.

The racking arrangement may be of any selected material. For cost and relative ease of fabrication, the racking arrangement components such as the uprights may comprise RHS or open channel metal such as steel or aluminium. The metal may be coated such as by painting or powder coating to reduce corrosion, or may be passivated or anodically protected against corrosion such as by electrolytic or hot-dip galvanizing, zinc-aluminium coating or the like.

The racking arrangement between the uprights will be selected having regard to the physical parameters of the platform per se. The seed bed at the beginning of the process is light; the fodder mat produced therefrom is heavy. The platform must resist considerable static loads without appreciable bending during the growing phase, and significant dynamic loads at the time of fodder mat stripping. While the platforms may be selected to be stiff and strong enough to be supported only at the end portions, it is preferred to support each of the platform members on at least one stringer located beneath the platform and extending between the respective end portions, the platform load on the stringer being translated to the uprights.

The uprights may comprise pairs of spaced uprights located at each of the end portions of the platform, the pairs at each end being interconnected by a cross member, and the cross members being interconnected by one or more stringers extending between the end portions and supporting the platform from underneath. At least some of the stringers may be located to provide a scaffold for supporting at least some elements of the irrigation and illumination systems.

The racking arrangement may support the platforms presenting a flat upper growing surface at an angle selected to retain the fodder seed bed during set up and germination phases, while providing adequate drainage. Seed bed retention involves control of many variables, including irrigation parameters, seeding rates and surface energy, as well as growing surface inclination. Drainage similarly is subject to many variables including but not limited to seed coat wettability, wettability of the growing surface of the platform, seed size and shape and its influence on capillary action in the seed bed, as well as inclination of the platform growing surface.

From the point of view of fodder feed sprouting grains using water irrigation, these require significant mechanical (i.e. forced impingement spray) wetting by the irrigation system, and tend to slump at seed loadings of more than 4.5 kg m⁻² for angles on inclination over 5° from the horizontal. However, drainage is highly variable with a mixture of dry and sodden patches, with sodden patches predominating at less than 6° inclination. Sodden patches promote seed rot and drowning of plantlets; dry patched do not germinate vigorously.

It has been surprisingly been determined that high seeding rates in excess of 8 kg m⁻² may be used, with adequate resistance to slumping of the seed mass under gravity, and with adequate drainage, on flat growing surfaces maintained at an inclination of about 4° from the horizontal. This is contrary to all prior art teaching and relies on carefully selected process conditions as described hereinafter. The platforms may comprise platform members each having a flat upper growing surface, wherein the inclination downward may be selected from between 3° and 5° from the horizontal, in choosing one or more of these process conditions. For reasons given hereinafter, it may be preferred to incline the flat upper growing surface at about 4° from the horizontal.

The essentially uninterrupted growing surface of the platform encourages simple raking to distribute seed for sprouting thereon. For example a simple straight edged paddle or gauge rake may be provided with a pair of spaced prongs to contact the surface and define an opening bounded by the surface, prongs and straight edge, the opening corresponding to a selected profile of the seed bed. The seed may be shovelled onto the platform then distributed with the gauge rake, the prongs controlling the seed bed depth.

The combination of the platforms sloping to a corridor space in the housing, and the lack of any lip, drain, upright or other impediment, enables the grown fodder mat grown to substantially the full length and breadth of the growing surface to be stripped off by sliding over the front edge. This is readily achievable by hand. The mat is heavy; it may be stripped to fall directly into a low cart that may enter the corridor though the opening in one end of the housing, and is wheelable to exit the opening in the other end of the housing. The platform is not removed at any time in the process.

The irrigation system may include a water supply selected from one or more of water storage means and a reticulated supply. For remote area use the water supply may be drawn from a rainwater collection point such as a tank or impoundment. In certain embodiments the water supply may include water collection means utilizing the roof of the housing as a water collection surface.

The irrigation system may include a pump or may utilize a pre-existing head pressure of the water supply.

The irrigation control means may comprise digital or analogue control. It is known to provide analogue programmable logic controllers that are entirely pneumatic or hydraulic in their operation and are therefore independent of electricity supply. However, the development of low voltage and inverter based electrical systems means that more cost effective electronic means such as a digital programmable logic controller may form the central element of the control means, even for remote installations. The irrigation control means may accordingly include a digital programmable logic controller.

The irrigation control means may operate a pump and/or valves in accordance with a selected program to deliver irrigation water to the spray nozzles, depending on the nature of the water supply. The nozzles are preferably selected from low impact nozzles. For example the nozzles may deliver one of more of a spray component, a drip component and a mist component, for reasons that will become apparent hereinafter. The nozzles for a particular platform may be supported on the underside of the platform above; in the case of platforms supported on one or more stringers, the nozzles and the lead-in pipework supplying them may be supported on the stringer(s) as a scaffold.

The irrigation system is central to the process of controlling the temperature within the housing. Accordingly, the irrigation system is provided with means of varying the temperature of the water from the water supply, as described hereinafter.

The irrigation system may further include treatment means for the irrigation water. The sprouting processes for which the apparatus of the present invention find use are not hydroponic processes; the processes are kept essentially nutrient-free to suppress the growth of microbiological contaminants. However, pre-dosing of the irrigation water with microbial suppressants, surface active agents and the like may be performed. Pre-dosing may be by dosing a water supply storage or by metered injection into delivery pipes to the sprinkler nozzles. Pre-treatment may include ozonation of the water supply. Pre-treatment may include dosing the water supply with a food grade non-ionic surfactant. Specific examples are described hereinafter with reference to the methods of the present invention.

The illumination system may be selected from fluorescent, incandescent or electronic lighting such as light emitting diode (LED) arrays. From the point of view of sheer efficiency, the use of LED arrays provides a substantial benefit. However, there are colour spectrum issues to address, and the capital cost of high intensity LEDs capable of delivering useful flux is relatively high. Fluorescent lighting has a relatively broad visible spectrum including frequencies not absorbed by photosynthetic (e.g. chlorophyll) and other metabolic chromophores. Efficiency losses via heating of transformer/ballast assemblies and cathode heating are significant. In the case of incandescent lighting, in extremely cold climates the high heat yield per lumen that would otherwise be an exorbitant energy impost may be tolerated. However, the radiant heat would in general be too extreme for the vertical densities considered economic. It is accordingly preferred to select the lighting from fluorescent lighting and LED lighting. Further efficiency may be obtained by leaving the illumination off during early-phase, non-photosynthetic germination.

While the sugar factory of photosynthetic plants is in the chloroplasts containing chlorophyll, there are many chromophores-bearing organic substances that contribute to plant metabolism and may be stimulated by light to encourage growth and productions. For example, while chlorophyll itself has two sharp absorption peaks at about 460 nm and about 665 nm, biologically important anthocyanins have peaks at about 525 nm and carotenoid compounds absorb in a range of 475 nm to 525 nm, with varying peak heights and areas under the absorption curves.

It is envisaged that sprouting fodder grains benefit differently from other more well characterized mature plants. For example, we would consider that promoting absorption by anthocyanins in fodder sprouts would be pointless but encouraging carotenoids might be beneficial, especially at high light flux for chlorophyll because of a protective effect. Accordingly, a combination of 4 LEDs@ 665 nm, 2 LEDs@ 460 nm, and 1 each of 475, 500 and 525 nm may be advantageous. However, such a precisely calibrated array is expensive.

It is known in hydroponic horticulture that the use of mixed frequencies of LED's, especially combinations of red and blue LED's may promote growth on a “weight of growth to watt-hrs consumed” basis. In the present case the applicant has determined empirically that the combination of LEDs that is metabolically favourable and achievable at the cheapest cost is a combination of LEDs in 36-watt per meter strips comprising 1 blue (450 nm) LED for every 8 red (700 nm) LEDs. For platforms having a net mat growing area of 2.2 m² with the use of a suitable collimating reflector of 2.2 m length, the strips yield an average flux of 36 Wm⁻². This arrangement of red and blue LEDs has resulted in 10% more kilograms per watt-hour when compared to a control strip of 36 Wm⁻² delivered by all-white LEDs.

The lighting controller may take any form in general dictated by the choice of lighting. The lighting controller may include a programmable timer function determining, according to a preselected program, a sequence of light and dark for a fodder production cycle or a part thereof. The lighting controller may comprise the same physical controller assembly as the irrigation controller. The program of lighting may be coordinated with the program of irrigations. The lighting or combined controller may comprise a programmable logic controller.

The temperature control means may take any form of control of the temperature of the water supply. The temperature of the irrigation water at the sprinkler head may be controlled to remain within a biologically acceptable range such as from about 10° C. to about 40° C. In environments having a diurnal average of about 18° C., it has been determined that for a selected irrigation input, an irrigation water temperature at the sprinkler heads of 23° C. will maintain a reasonable growing temperature in the environment inside the housing.

In environments having a diurnal average of about 18° C. and in fine weather, it has been determined that conditions inside the housing may be maintained within the range of 18 to 23° C. and 40 to 80% relative humidity (RH) by irrigation water temperature control alone, with a program of air exchange. For growing barley, for example, the optimal conditions of a temperature of about 23° C. at a humidity of between 40 and 80% RH are obtainable. In adverse external weather conditions, conditions inside the housing may be maintained within the range of 18 to 23° C. and 40 to 80% relative humidity (RH) by irrigation water temperature control, with a program of air exchange, and temperature and/or relative humidity control supplemented by the use of heat pump means such as a reverse cycle air-conditioning unit.

The energy source for heating or cooling the water may be selected from heat pump means including reverse-cycle heat pump means, combustion heating such as solid or liquid fuel or gas, electric immersion heater mean or solar thermal means. The temperature control means may include tempering valve means, which enables the water supply to mix two sources, a hot water source and a cold water source, to deliver the controlled temperature irrigation water demanded to meet the programs of both temperature control and irrigation. The hot water source may comprise a solar thermal accumulator.

The temperature control means may be adapted to heat or cool the environment inside the housing.

The nature of the platforms may be to act as a thermal buffer, wherein water passing through the seed or sprout may transfer heat to or extract heat from the platform. The platform thereafter functions as a heat sink or source for equilibration with its surroundings between irrigation cycles. This is facilitated by the slow passage of the irrigation water down the modest and preferred 4° slope. The slow passage also minimizes run-off the platform front lip to a floor drain.

The energy requirements of the apparatus of the present invention will most often comprise a thermal component and an electrical component. While the total energy requirement may be met by mains power, it is envisaged that economic operation in mains-connected areas may comprise a hybrid mains power/thermal solar system, whereby water supply heating is by the aforementioned solar thermal means (supplemented by an immersion heater when necessary) and electronic control, lighting and ventilation is done by electrical means powered by the mains supply.

In remote applications it is envisaged that the total energy needs be met by a solar thermal/solar PV hybrid system, whereby solar PV panels charge storage batteries and a solar thermal arrangement heats an insulated reservoir. The storage batteries may power LVDC equipment directly or power AC equipment via an inverter. In remote applications, it is expected that the solar PV and solar thermal elements will have significant reserve capacity. However, the system may be supplemented by a genset and/or external water heater if there are area constraints. The solar PV and/or solar thermal collectors may be mounted on the housing roof.

The irrigation, illumination and ventilation systems may have their respective control means integrated into a control assembly. The control assembly may include an environmental housing for one or both of a storage battery bank and an integrated electronic control panel, the relative warmth and high humidity of the growing environment being inimical for both systems. The electronic control panel may include a programmable logic controller for each of the irrigation, illumination and ventilation subsystems, or may include a multi-channel programmable logic controller. The electronic control panel may include one or more a user interfaces providing for programming of subsystem parameters, isolation switching and/or manual override. The user interface may include one or more of a membrane-protected key panel, with a touch or display only screen, a wired or wireless interface to a laptop or tablet computer and a dedicated use interface device.

According to another aspect of the present invention there is provided a fodder growing method including:
providing a plurality of vertically-spaced platforms supported in an insulated housing, each platform being supported at each of spaced end portions, the end portions being interconnected by a rear edge and a substantially unobstructed front edge, said platform being inclined downward from said rear edge to said front edge, with spray nozzles and lighting means supported over each of said platforms;
distributing fodder sprout seeds to form a seed bed of substantially constant selected thickness on said platforms;
subjecting said seed bed to a program of irrigation from a water supply to said nozzles and lighting from said lighting means for a period of time to germinate and grow the seed bed to a fodder mat, the temperature within the housing being controlled by controlling the temperature of said water supply.

The vertically-spaced platforms, insulated housing, platform supports, spray nozzles and lighting means may be as per the description above.

The fodder sprout seed may be distributed on the platforms by any suitable means, such as by a straight edged paddle or gauge rake with a pair of spaced prongs to contact the platform and define an opening bounded by the platform, prongs and straight edge, the opening corresponding to a selected profile of the seed bed. The seed bed may comprise a monolayer of seeds. The density of nutritious feed is increased, and the economies of production are accordingly increased, by increasing the seed loading on the platform. The maximum seed bed depth is determined by the ability of the bed to sprout without causing a high percentage of failures to germinate, or a high percentage of germinated spouts dying, such as from surfeit of metabolic products. Management of sprouting parameters including seed bed depth all contribute in reducing rot and other fruits of contamination. For example, high germination rates with excessive sprout death is associated with excessive free sugars such as maltose, with attendant increased risk of fungal, bacterial and protozoan proliferation.

The prior art methods referred to herein are capable of fodder seeding rates of up to 4.5 kgm⁻². It has been found that by management of defined parameters, seeding rates using methods and apparatus of the present invention may be at least 8 kgm⁻².

Fodder growing seeds for use in the present invention may be pre-treated. For example, the seeds may be treated to reduce the prevalence of spores or bacteria, thus statistically reducing the likelihood of contamination. The seed may be pre-treated with a wetting agent to promote wetting out of the seed bed whilst encouraging free drainage.

The fodder growing unit of the present invention may be used to sprout a variety of grains and seeds for livestock and human consumption including barley, alfalfa, sunflowers, mung beans, wheatgrass, fenugreek, onion, snow peas, and the like.

There is a circumstance of tertiary complexity governing seed beds of the type and density envisaged for use in the present invention. Seed bed retention from physical slumping implies platforms of about 4° slope as discussed above. The seeds themselves tend to have a hydrophobic coat. Whilst this may be stripped by for example pre-washing with sodium hypochlorite solution, there are mortality and chemical contamination issues associated with this method. The hydrophobic seeds, when in the seed bed, wet out very unevenly. Some patches are suitably wet, others are essentially saturated by capillary action, and others are dry to the point of not germinating. The monolayer against the platform itself tends not to drain at all without hydrostatic head from above in the seed bed, being maintained at the 4° slope by capillary action.

It has been surprisingly determined that controlled dosing of the water supply with a suitable food-grade non-ionic surfactant essentially solves the complex interplay of factors and promotes an even wetting out of the seed bed, and including free drainage of the monolayer adjacent the platform growing surface. This wetting out principle, combined with a platform drainage slope of about 4° and selection of a watering regime closely controlled by a PLC, may result in water consumption as low as 2 litres per kilo of finished fodder sprouts. By this means, the untreated seed may substantially address the deleterious effects of uneven germination and growth, rotting from the bottom up and the like, and enables the growing of fodder mats on seeding rates of more than 8 kgm⁻².

The food-grade non-ionic surfactant may be selected from long-chain alcohols such as cetyl alcohol, stearyl alcohol, cetostearyl alcohol and oleyl alcohol, Polyoxyethylene glycol alkyl ethers (CH₃—(CH₂)₁₀₋₁₆—(O—C₂H₄)₁₋₂₅—OH), Octaethylene glycol monododecyl ether, Pentaethylene glycol monododecyl ether, Polyoxypropylene glycol alkyl ethers (CH₃—(CH₂)₁₀₋₁₆—(O—C₃H₆)₁₋₂₅—O), Glucoside alkyl ethers (CH₃—(CH2)₁₀₋₁₆—(O-Glucoside)₁₋₃-OH), Decyl glucoside, Lauryl glucoside, Octyl glucoside, Polyoxyethylene glycol octylphenol ethers (C₈H₁₇—(C₆H₄)—(O—C₂H₄)₁₋₂₅—OH such as Triton X-100, Polyoxyethylene glycol alkylphenol ethers (C₉H₁₉—(C₆H₄)—(O—C₂H₄)₁₋₂₅—OH, Nonoxynol-9), Glycerol alkyl esters such as Glyceryl laurate, Polyoxyethylene glycol sorbitan alkyl esters (e.g. Polysorbate, Tween 60, Tween 80), Sorbitan alkyl esters (e.g. Spans), Cocamide MEA, cocamide DEA, Dodecyldimethylamine oxide, Block copolymers of polyethylene glycol and polypropylene glycol (Poloxamers), and Polyethoxylated tallow amine (POEA).

The method or the present invention may include supplementary treatment means. For example, a further antimicrobial effect may be had from associating an O₃ (ozone) generator with the housing air or water supply. Ozone is a corrosive and irritating gas. As the interior of the housing is a workplace, it is desirable to maintain any ozone treatment at a level where the ozone content of the air is less than permissible exposure limit of 0.1 mol/mol or 100 ppb (parts per billion), calculated as an 8 hour time weighted average. Higher concentrations may be used with a program of air purging before entry. At all times the ozone concentration is preferably below the concentration immediately dangerous to life and health of 5 mol/mol.

Ozonation may be done by way of ozone generation in conjunction with the water supply. The water supply may be associated with, for example, a vacuum-ultraviolet (VUV) ozone generator. VUV ozone generators, unlike corona discharge generators, do not produce harmful nitrogen-oxide by-products and also unlike corona discharge systems, VUV ozone generators work extremely well in humid air environments. Alternatively, electrolytic ozone generation (EOG), which splits water molecules into H₂, O₂, and O₃, may be used, provided that the hydrogen gas is safely dispersed. Ozone is only sparingly soluble in water. Accordingly ozonation of the water supply is safe.

It has been surprisingly determined that ozonation of the water results in faster germination. It is surmised that ozone assists in stripping the natural hydrophobic surface from the dry seed. It may also be that decomposition of the ozone yields oxygen available to promote the germination process which, as described above, is an oxygen dependent respiratory process.

Ozone may also be injected into the incoming air of the room. This may assist to keep the room clean and substantially sterile.

The watering program may take any suitable form consistent with sprouting of the seeds. Since the process is not hydroponic, there is no need to recirculate to conserve nutrients. In fact it is preferred that there is no recirculation to reduce risk of contamination. The watering program may be selected whereby there is a minimum of drainage over the front edge of the platforms. Such drainage as necessarily must occur may pass to a trough formed in the floor and thence to a floor drain, be collected by a lip drain below the free edge for conveyance to the platforms ends and thence to drain, or the like.

The details of the watering program are determined empirically depending on the nature of the seed bed. However as a generally applicable rule it has been determined that the watering program be characterized by medium application rates for initial wetting out, low rates for initial cotyledon break out, medium rate to initial photosynthetic transition, and high rate for the photosynthetic growth phase. In this context the rates of application may be achieved by modifying either the time of operation of the nozzles or by the rate of flow through the nozzles. For example, the “low application rate” may comprise frequent misting applications for the initial 48 hours of a 6-day growing cycle, whereas the medium application rate may be less frequent but more akin to “watering”.

It has been empirically determined that an initial period of “wetting out” may involve running the irrigation nozzles for 30 seconds per hour on the first day, in frequent applications of short duration. This minimizes run-off while wetting out, at a time of low water uptake. On the second day, with metabolic processes changing from quiescent to active, the watering regime may be less frequent but of longer duration, while delivering the same rate, that is 30 seconds per hour. Day three may be expected to be the peak of water consumption as the sprouts build enough hydrated mass to support photosynthesis under constant light. For example the rate may be increased by a third by increasing the duration of spraying (that is, a net rate of 40 sec/hr). Days 4 and 5 may represent a “steady state” of photosynthetic growth under constant light, with a water requirement throttled back to a nozzle-on time of, for example, 30 seconds per hour. The developing mat is now at a stage where the rate can be delivered at say 30 second duration sprays once every hour. The sixth day is a “hardening” day with a further reduced watering requirement of say 30 second duration sprays once every hour and a half. Such a regime will cater for growth of mats from seed beds laid at more than 8 kgm² while registering a water consumption of less than 2 litres per kg of feed produced.

The control of the lighting may include control of the periodicity of the lighting and the intensity of the lighting. In the case of the preferred LED lighting, the control means preferably switches the lighting on and off. During the germination phase, the dynamics of plant growth are governed more by warmth and moisture than light. It is preferred to economize the program by switching on the illumination on, for example, Day 3 of the above irrigation program. Thereafter, the illumination is preferably constant from the third day to the sixth day.

Once grown, typically 6 days in the case of fodder, the harvested plants are removed from the platform, either by hand or machine, the platforms are washed and cleaned, and the process re-initiates. At a seeding rate of greater than 8 kgm⁻² it follows that the grown fodder mat will exceed the OH&S limits for manual handling. Accordingly, the corridor between adjacent rows of platforms may form a passage in which a wheeled trolley may pass, the fodder mat being manually dragged down-slope off the platform to fall on to the trolley under gravity.

### DESCRIPTION OF THE DRAWINGS

FIG. 1 is a partially cut-away perspective view of the embodiment;

FIG. 2 is an internal plan view of the embodiment;

FIG. 3 is an internal side elevation of the embodiment;

FIG. 4 is an internal end elevation of the embodiment;

FIG. 5 is a detail side view of a racking system for use in the embodiment;

FIG. 6 is a detail end view of the racking system of FIG. 5; and

FIG. 7 is a detail perspective view of a platform for use in the racking system of FIGS. 5 and 6.

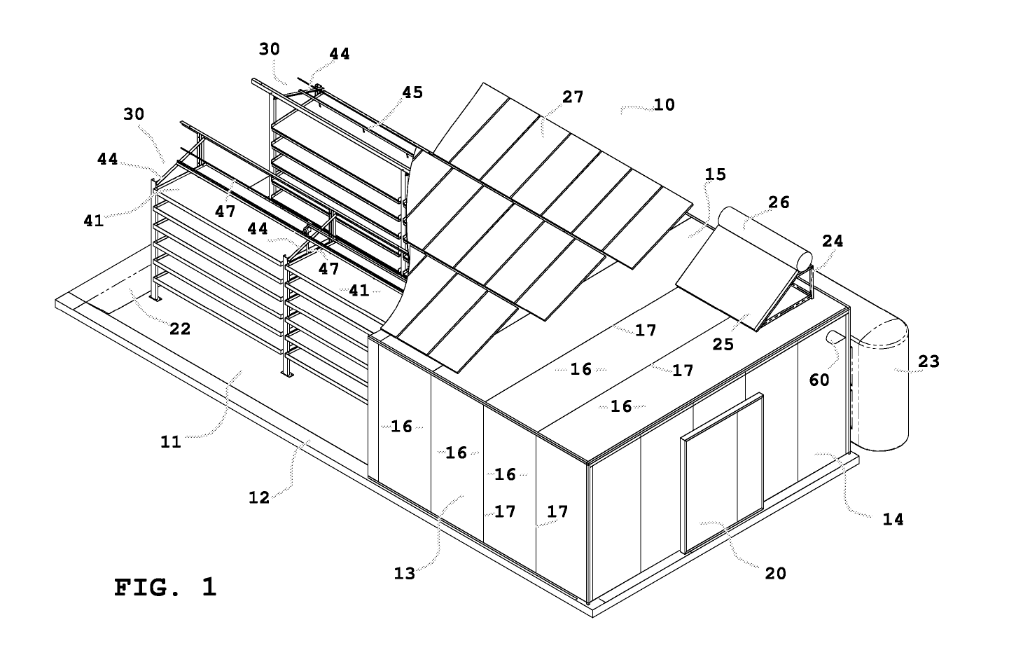

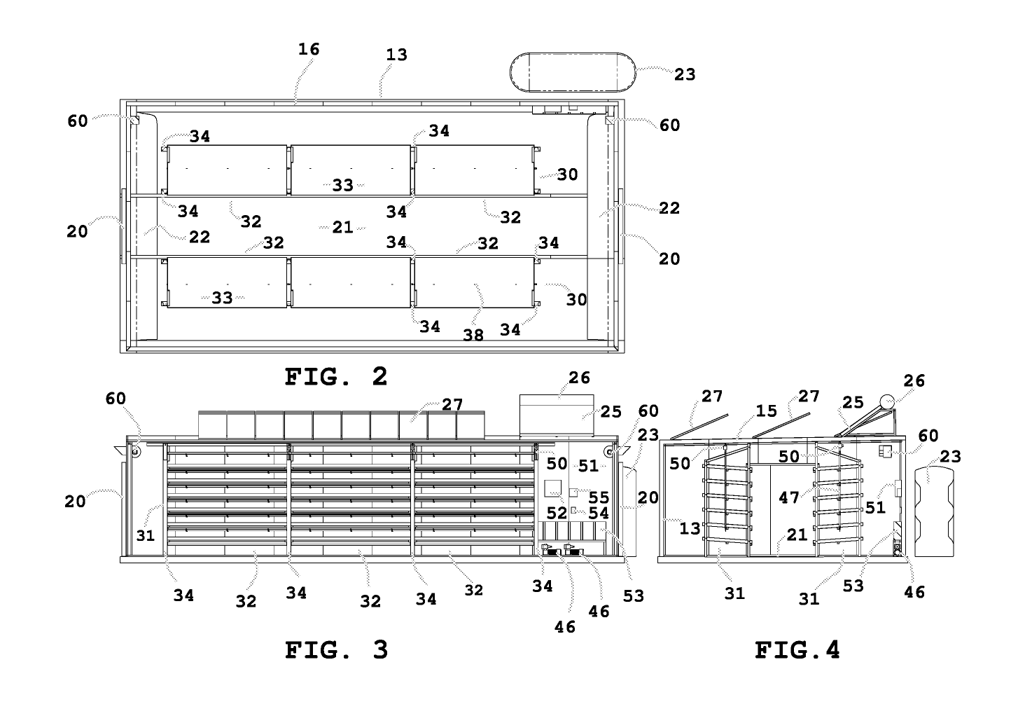

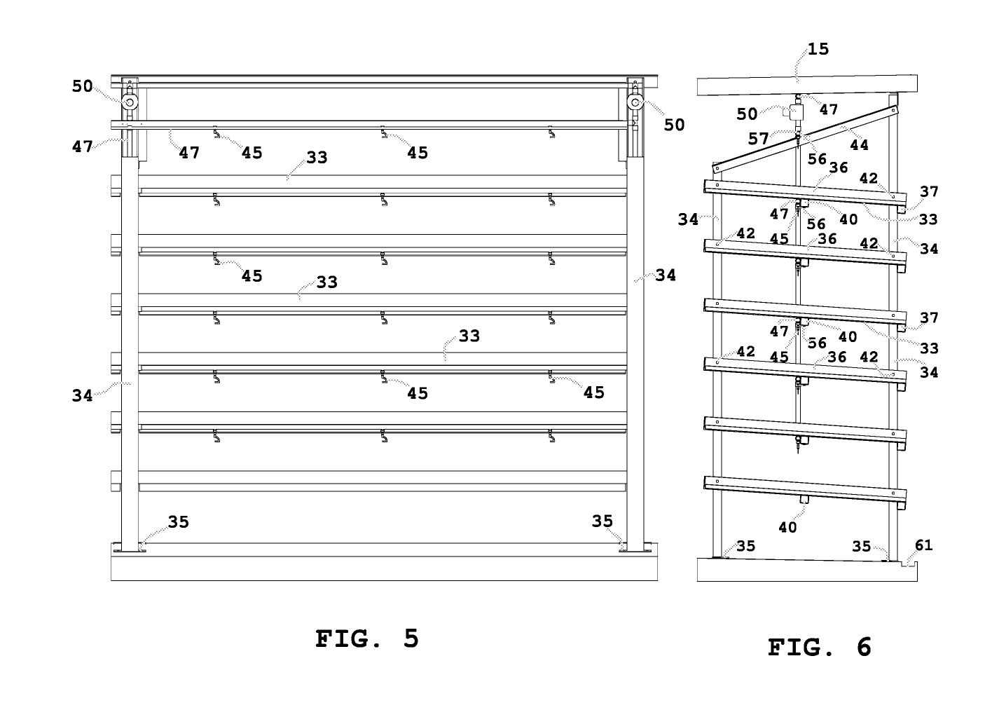

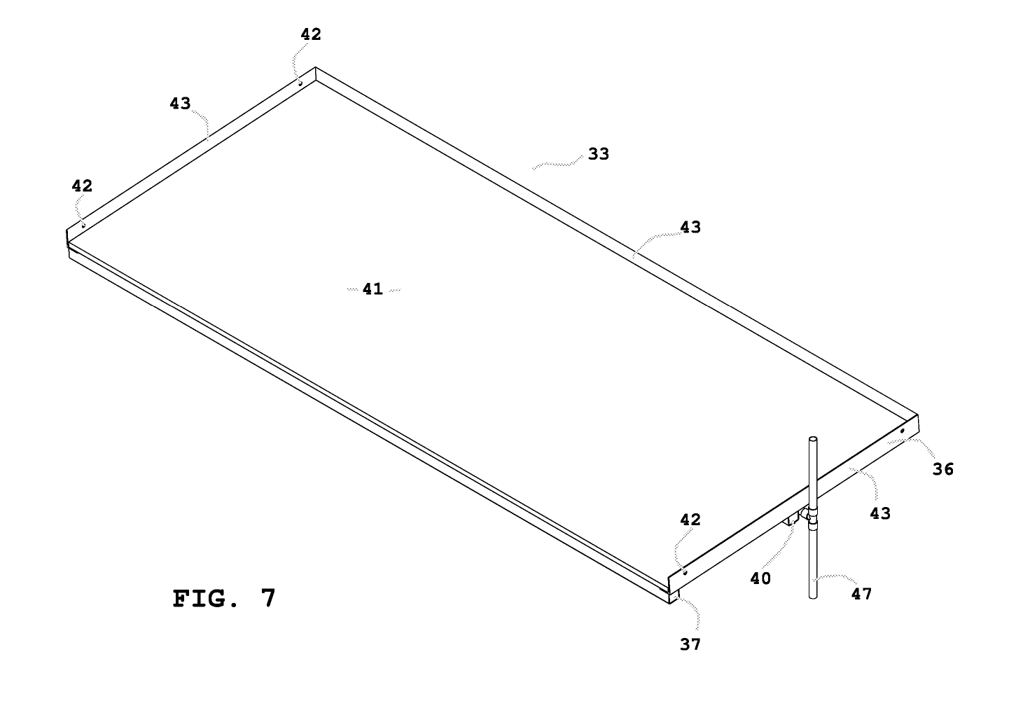

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

In the drawings there is provided a fodder growing system 10 including a concrete slab-on-ground 11 and integral reinforced concrete edge beams 12. The edge beams 12 support an insulated enclosure comprising side walls 13, end walls 14 and a top wall 15, each comprising a plurality of metal skinned insulated panels 16 supported on metal frame members at the panel joins 17. The end walls 14 each have an insulated door 20; when the respective doors 20 are opened, an end-to end passage 21 is defined through the enclosure. A height difference between the edge beams 12 and the slab 11 at the doors 20 is matched by integral concrete ramps 22. By this means a wheeled trolley or the like may pass through the enclosure from one end to the other.

To the outside of the enclosure is located a water storage tank 23, supplied at least in part by rain water collected on the top wall 15. An electrically boosted solar thermal water heater 24 is mounted on the top wall 15 and comprises a thermal solar collector 25 heating an insulated accumulator tank 26. A solar PV panel array 27 generates electrical power to meet the electrical energy needs of the fodder growing process, excess electrical energy being stored in a bank of deep cycle storage batteries.

Arranged on each side of the end-to-end passage 21 are growing assemblies 30, in this case each comprising a rack assembly 31 divided into three bays 32 each supporting six platform assemblies 33. The rack assemblies each include four pairs of spaced uprights 34 formed of galvanized RHS steel, supported on load pads 35 on the slab 11.

The platform assemblies 33 comprise a three-sided galvanized angle frame portion 36 welded to front 37 and intermediate 40 galvanized RHS stringers. An MgO filled composite platform 41 is bonded to the upper surfaces of the frame portion 36 and stringers 37, 40 with gap filling, elastomeric, moisture cure SIKAFLEX®. Set-up location of the composite platform 41 is achieved by three spaced, countersunk, stainless-steel, self-drilling screws 38 securing the platform 41 to the intermediate stringers 40

The platform assemblies 33 are bolted in vertically spaced relation between adjacent pairs of spaced uprights 34 via bolt holes 42. The upward-directed web 43 of the frame portion 36 forms a spillage and root mat dam in use. The platform assemblies 33 are bolted to the uprights 34 to present the upper surface of the platform 41 at an inclination of about 4° downward toward the free edge of the platform 41 not occluded by the web 43 of the frame portion 36. As the platform assemblies 33 are substantially parallel, as are the uprights, the assembly is braced against collapse by a plurality of upper braces 44 each bolted between the uprights 34 forming a respective pair.

An irrigation system connects the water storage tank 23 and the hot water accumulator tank 26 to a plurality of spray nozzles 45 supported over each of said platform assemblies 33. The reticulation aspects of the irrigation system comprise a 140 kPA pressure-switch controlled water pump 46, one of which pumps water from the storage tank 23 through a heat exchange coil in the accumulator tank 26, and the other of which draws directly from the storage tank 23. Both pump 46 outlets feed an electronically controlled tempering valve (not shown) adapted to control the temperature of the combined outflow to a temperature selected by means described hereinafter. The combined outflow passes to the spray nozzles 45 via a piping manifold 47 including electronically controlled valves 50.

An integrated control assembly includes an environmental housing 51 containing a multi-channel programmable logic controller (PLC), electrical distribution board, and a solar panel regulator. A user interface touch screen 52 interprets and provides user control over the PLC and provides historical and current system data. A bank of sealed AGM deep-cycle batteries 53 is charged by the solar panels 27 and in turn powers the control assembly, pumps 46 and other functions as described hereinafter. The environmental housing 51 is also provided with a master isolation switch 54 and a protected data port assembly 55 for programming via an external laptop or tablet device. The integrated control assembly includes switching power to an immersive electrolytic ozonation device associated with the water storage tank 23.

The water storage tank is does with food grade, non-ionic surfactant (Tween 60) and is maintained at between 0.05% v/v (hot weather) and 0.1% v/v (cold weather), having regard to the expected mixing ratio imposed by the tempering valve and the PLC controlling it.

The irrigation system is completely controllable by means of the PLC controlling a time cycle of irrigation, the PLC timer switching on irrigation by opening the electronically controlled valves 50. The pumps 46 per se are automatic; the pressure switches enable all flow control to be managed by PLC switching of the electronically controlled valves 50. This enables a constant head to be maintained to close to the nozzles 45, preventing drain-back and allowing precise control of volumes by time and cycle duration alone. The PLC controls precise dosing of the irrigation water with non-ionic surfactant downstream of the tempering valve.

A typical irrigation regime may be as per Table 1:

TABLE 1

| | Water Duration | Interval |
|---|---|---|
| | (sec) | (mins) |
| Day 1 | 10 | 20 |
| Day 2 | 15 | 30 |
| Day 3 | 20 | 30 |
| Day 4 | 30 | 60 |
| Day 5 | 30 | 60 |
| Day 6 | 30 | 90 |

The delivery of irrigation water over the 6 day program is selected to be between 2 and 3 litres per kg of grown sprouts.

Temperature control is invoked by PLC-interface screen 52-selecting an irrigation temperature at the electronically controlled tempering valve or by selecting a tempering valve program based on a temperature sensor in the housing, the apparatus being capable of either method of temperature control. In the present case, the tempering valve control by the PLC is set at about 23° C. when the fixed-method is chosen, and is selected to approximately average 23° C. when programmed for diurnal variation.

The illumination system comprises light emitting diodes (LEDs) 56 in 36-watt per meter strips comprising 1 blue (450 nm) LED for every 8 red (700 nm) LEDs. The strips of LEDs 56 are mounted to the intermediate stringers 40 over the platform assembly 33 below, except in the case of the top platform assembly 33 where the strip is mounted to a dedicated bracket 57. The strips, stringers 40 and brackets 57 cooperated to yield an average flux of 36 Wm⁻². The PLC is programmed to switch the LEDs over a 6-day growing cycle. Unlike prior art systems where illumination time is restricted to control mould growth, after the initial germination period of about 2 days when the illumination is turned off by the PLC, from the 2^{nd} to the 6^{th} days of a typical 6-day fodder growing cycle the illumination is on full-time.

A pair of exhaust blowers 60 under timer control by the PLC are operated to exchange two housing volumes of air per day for the first 2.5 days and one housing volume per day thereafter, in order to maintain oxygenation levels during the respiration-dominated germination phase of the growing cycle. In addition, the PLC coordinates operation of a UV air Ozonation device (not shown) with the air exchange exhaust blowers 60.

In order to prevent contamination and infection, there is no irrigation recycling; any non-absorbed irrigation water passes to waste via floor drains 61.

Particular terminology used when describing certain features or aspects of the invention should not be taken to imply that the terminology is being redefined herein to be restricted to any specific characteristics, features, or aspects of the invention with which that terminology is associated. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above.

The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention. Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein.

As noted above, particular terminology used when describing certain features or aspects of the invention should not be taken to imply that the terminology is being redefined herein to be restricted to any specific characteristics, features, or aspects of the invention with which that terminology is associated. While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1-59. (canceled)

60. A fodder growing system including:
an insulated housing;
a plurality of vertically-spaced platforms supported in said housing, each platform being supported at each of spaced end portions, the end portions being interconnected by a rear edge and a substantially unobstructed front edge, said platform being inclined downward from said rear edge to said front edge;
an irrigation system including irrigation control means for delivery of a selected irrigation program from a water supply to spray nozzles supported over each of said platforms;
an illumination system including illumination control means controlling a lighting means supported over each of said platforms; and
temperature control means controlling the temperature within said housing by controlling the temperature of said water supply.

61. A fodder growing system according to claim 60, wherein the housing comprises a building having a floor, two opposed end walls and two opposed side walls interconnecting the end walls, the side and end walls being formed of insulated panels, an insulated-panel top wall comprising both roof and ceiling of the building, and a pair of doors selectively closing respective opposed openings in the end walls, said opposed openings defining a passage through the building, said passage being defined within the housing by platforms on both sides of the passage.

62. A fodder growing system according to claim 60, wherein the housing includes ventilation means including a fan assembly operable as one or more of a blower, extractor or recirculator of the air inside the housing, and operable by control means to effect a fresh air change of about two housing volumes per day.

63. A fodder growing system according to claim 62, wherein the ventilation means includes air conditioning means.

64. A fodder growing system according to claim 60, wherein the platforms comprise a rack assembly supporting a plurality of platform members comprising a material having a chemically and biologically inert, waterproof and non-absorbent surface, said platforms being substantially flat on their upper surface between boundary edges thereof, the flat platform upper surface extending to an uninterrupted sheer boundary at the front edge.

65. A fodder growing system according to claim 60, wherein the platforms comprise platform members each having a flat upper growing surface, said inclination downward being selected from between 3° and 5°, preferably about 4°, from the horizontal.

66. A fodder growing system according to claim 60, wherein the irrigation control means includes a digital programmable logic controller and the irrigation control means operates a pump and/or valves in accordance with a selected program to deliver irrigation water to the spray nozzles, said nozzles being selected from low impact nozzles selected to deliver one of more of a spray component, a drip component and a mist component.

67. A fodder growing system according to claim 66, wherein the irrigation system further includes treatment means for the water supply and selected from one or both of ozonation of the water supply, and dosing the water supply with a food grade, non-ionic surfactant.

68. A fodder growing system according to claim 60, wherein the illumination system is selected from light emitting diode (LED) arrays comprising 4 parts LEDs@ 665 nm, 2 parts LEDs@ 460 nm, and 1 each parts of 475, 500 and 525 nm.

69. A fodder growing system according to claim 68, wherein the LED arrays comprise a combination of LEDs in 36-watt per meter strips comprising 1 blue (450 nm) LED for every 8 red (700 nm) LEDs.

70. A fodder growing system according to claim 60, wherein the illumination control means includes a programmable timer function determining, according to a preselected program, a sequence of light and dark for a fodder production cycle or a part thereof.

71. A fodder growing system according to claim 60, wherein the temperature control means controls the temperature of the irrigation water at the spray nozzles to be from about 10° C. to about 40° C., and preferably about 23° C.

72. A fodder growing system according to claim 71, wherein the conditions inside the housing are maintained within the range of 18 to 23° C. and 40 to 80% relative humidity (RH) by irrigation water temperature control alone, with a program of air exchange.

73. A fodder growing system according to claim 60, wherein the platforms are selected to act as a thermal buffer.

74. A fodder growing system according to claim 60, wherein the irrigation, illumination and ventilation systems have their respective control means integrated into a control assembly, the control assembly including an environmental housing for one or both of a storage battery bank and an integrated electronic control panel including a multi-channel programmable logic controller for irrigation, illumination and ventilation subsystems, the electronic control panel including one or more a user interfaces providing for programming of subsystem parameters, isolation switching and/or manual override.

75. A fodder growing method including:
providing a plurality of vertically-spaced platforms supported in an insulated housing, each platform being supported at each of spaced end portions, the end portions being interconnected by a rear edge and a substantially unobstructed front edge, said platform being inclined downward from said rear edge to said front edge, with spray nozzles and lighting means supported over each of said platforms;
distributing fodder sprout seeds to form a seed bed of substantially constant selected thickness on said platforms;
subjecting said seed bed to a program of irrigation from a water supply to said nozzles and lighting from said lighting means for a period of time to germinate and grow the seed bed to a fodder mat, the temperature within the housing being controlled by controlling the temperature of said water supply.

76. A fodder growing method according to claim 75, wherein the seeding rate is selected to be at least 8 kgm⁻².

77. A fodder growing method according to claim 75, wherein the fodder growing seed are selected from one or more of barley, alfalfa, sunflowers, mung beans, wheatgrass, fenugreek, onion, snow peas, and the like.

78. A fodder growing method according to claim 77, wherein the water supply is dosed with a food-grade non-ionic surfactant, said inclination downward from said rear edge to said front edge forms a drainage slope of about 4° and said program of irrigation is controlled by a PLC to about 2 litres per kilogram of finished fodder sprouts.

79. A fodder growing method according to claim 75, wherein there is further includes treating the air within the housing with ozone at a level where the ozone content of the air is less than 0.1 μmol/mol or 100 ppb (parts per billion), calculated as an 8 hour time weighted average.

80. A fodder growing method according to claim 75, wherein the program of irrigation comprises:
(i) an initial period of “wetting out” by running the irrigation nozzles for 30 seconds per hour on a first day, in frequent applications of short duration;
(ii) a second day regime of less frequent but of longer duration, delivering the 30 seconds per hour at 15 second duration at a 30 minute intervals;
(iii) a third day regime at a net rate of 40 sec/hr, comprising 20 second duration and 30 minute intervals;
(iv) a fourth and fifth day regime of 30 seconds per hour; and
(v) a sixth day regime of 30 second duration sprays once every hour and a half.

81. A fodder growing method according to claim 75, wherein the program of illumination operation of a combination of LEDs in 36-watt per meter strips comprising 1 blue (450 nm) LED for every 8 red (700 nm) LEDs, wherein the growing cycle is a 6-day cycle and the illumination is constant from the third day to the sixth day.
